(19) United States
(12) Patent Application Publication
(10) Pub. No.: US 2011/0310152 A1
(43) Pub. Date: Dec. 22, 2011

(54) INKJET PRINTING DEVICE AND INKJET PRINTING METHOD

(75) Inventors: Kentarou Muro, Tokyo (JP); Yutaka Kano, Yokohama-shi (JP); Susumu Hirosawa, Tokyo (JP)

(73) Assignee: CANON KABUSHIKI KAISHA, Tokyo (JP)

(21) Appl. No.: 12/963,690

(22) Filed: Dec. 9, 2010

(30) Foreign Application Priority Data
Jun. 22, 2010 (JP) 2010-141659

(51) Int. Cl. B41J 29/38

(52) U.S. Cl. 347/14

(57) ABSTRACT

An inkjet printing device that performs printing on a print medium with a print head including a nozzle for discharging ink, includes: a transport unit transporting the print medium; a printing unit discharging the ink while transporting the print medium such that the printing unit prints an image for printing and an image formed by a preliminary discharge; a first limiting unit limiting, based on image data on the image for printing, an ink amount to be discharged such that the amount of ink per unit area is equal to or less than an upper limit Alim; and a second limiting unit limiting an ink amount to be discharged for the image formed by the preliminary discharge such that the amount of ink per unit area is more than the upper limit Alim and is equal to or less than an upper limit Blim.

### BACKGROUND OF THE INVENTION

1. Field of the Invention

The present invention relates to an inkjet printing device and an inkjet printing method.

2. Description of the Related Art

When an ink discharge port provided in a print head of an inkjet printing device is not used for a long time, an ink solvent within the ink discharge port evaporates and thus the viscosity of the ink can be increased. In this case, even when a drive signal is applied to an element that produces energy utilized for discharging the ink, the ink is not properly discharged, and this causes a discharge failure such as variations in the direction in which the ink is discharged, an insufficient amount of ink discharged or unsuccessful discharge, with the result that it may be impossible to acquire a desired image. In order to eliminate the cause of the above-described discharge failure and acquire the satisfactory ink discharge performance of the print head, for example, an operation referred to as a preliminary discharge is often performed. Specifically, the preliminary discharge is an operation of driving an element that produces energy utilized for discharging ink and thereby discharging the ink so as to release from a discharge port the ink in a state where part of a volatile component evaporates and thus the discharge performance and the printing quality are unsatisfactorily acquired. The preliminary discharge is an operation that is different from a printing operation of forming an objective image and that copes with the discharge failure resulting from the evaporation of an ink solvent; when the preliminary discharge is performed on a print medium, an image is consequently printed. Japanese Patent Application Laid-Open No. 2008-213471 proposes a method for performing a preliminary discharge in a predetermined position of a print medium.

Incidentally, in inkjet printing, in general, as a larger amount of ink is discharged on a print medium, the degree of color reproduction of an image can be increased. However, if an amount of ink that exceeds the ink absorption performance of the print medium is discharged, the ink that is not fully absorbed into the print medium can cause so-called bleeding such as ink blurring or uneven mixing in images. Moreover, a problem such as a stain may occur in which an excessively larger amount of ink overflows the print medium, adheres to a transport unit and is transferred to a print medium. In order to solve these problems, there is conventionally proposed a printing method in which the amount of ink per unit area used for the formation of an image is previously set based on an upper limit for the amount of ink per unit area that does not cause a problem such as bleeding (for example, see Japanese Patent Application Laid-Open No. 2005-125602).

However, since the preliminary discharge is not a printing operation for the formation of an image for the purpose of printing, part of a print medium where an image is printed by the preliminary discharge becomes unnecessary trash, and this increases the cost of printing. If the preliminary discharge is performed in a smaller area on the print medium to reduce the cost, a necessary number of discharges to eliminate the discharge failure of a nozzle may cause an amount of ink exceeding its ink absorption performance to be supplied to the area of the print medium.

### SUMMARY OF THE INVENTION

To overcome these problems, an object of the present invention is to provide an inkjet printing device and an inkjet printing method that can perform printing in which an area of a print medium used by a preliminary discharge is minimized and in which ink that is not absorbed into the print medium and causes a problem such as a stain is not produced.

To achieve the object, an inkjet printing device according to the present invention that performs printing on a print medium with a print head including a nozzle for discharging ink, includes: a transport unit transporting the print medium; a printing unit discharging the ink from the print head while the transport unit transports the print medium, such that the printing unit prints an image for printing on the print medium and an image formed by a preliminary discharge; a first limiting unit limiting an amount of ink to be discharged per unit area of the print medium based on image data on the image for printing such that the amount of ink per unit area is equal to or less than an upper limit Alim; and a second limiting unit limiting an amount of ink to be discharged per unit area of the print medium for the image formed by the preliminary discharge such that the amount of ink per unit area is more than the upper limit Alim but is equal to or less than an upper limit Blim.

According to the present invention, it is possible to provide an inkjet printing device that can print both the objective image that satisfies bleeding performance and the preliminary discharge image that causes no stain in a transport unit resulting from the overflow of ink. Thus, it is possible to reduce the quantity of print media consumed.

Further features of the present invention will become apparent from the following description of exemplary embodiments (with reference to the attached drawings).

### BRIEF DESCRIPTION OF THE DRAWINGS

FIG. 1 is a schematic side view of an inkjet printing device according to first and second embodiments;

FIG. 2 is a schematic plan view showing an ink discharge surface of a print head according to the first embodiment;

FIG. 3 is a diagram showing the positional relationship between an objective image and a preliminary discharge image;

FIG. 4 is a diagram showing an example of an upper limit conversion table;

FIG. 5 is a flow showing an image printing method according to the first embodiment;

FIG. 6 is a schematic plan view showing an ink discharge surface of a print head according to the second embodiment;

FIG. 7 is a diagram showing a preliminary discharge image formed by the print head according to the second embodiment;

FIG. 8 is a schematic side view of an inkjet printing device according to a third embodiment; and

FIGS. 9A and 9B are diagrams showing preliminary discharge images according to the third embodiment.

### DESCRIPTION OF THE EMBODIMENTS

Preferred embodiments of the present invention will be described below with reference to the accompanying drawings.

### First Embodiment

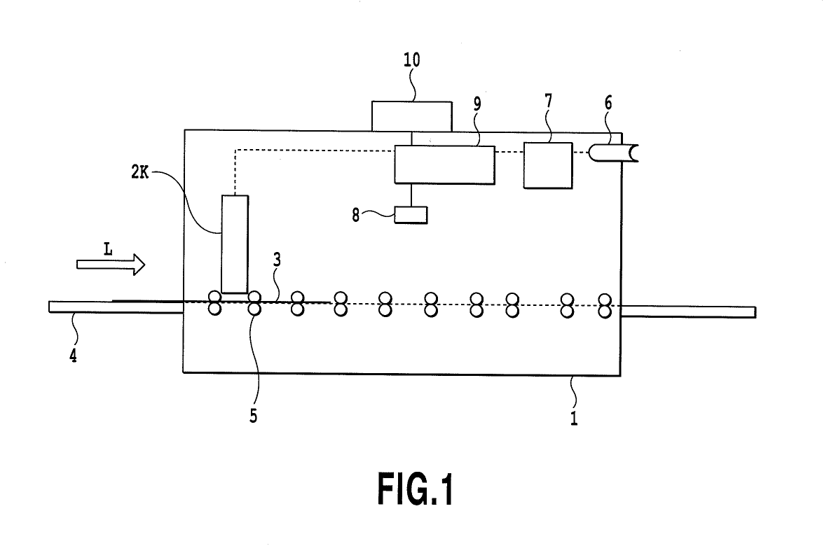

FIG. 1 is a schematic side view showing an inkjet printing device according to a first embodiment of the present invention. The inkjet printing device 1 of the present embodiment includes a print head 2K, a paper feed tray 4, transport rollers 5, an image data input unit 6, an image data processing unit 7, a preliminary discharge image data storage unit 8, a control unit 9 and an upper limit setting unit 10. A print medium 3 is fed from the paper feed tray 4 into the inkjet printing device 1. The transport rollers 5 are composed of a plurality of pairs of rollers, and can vertically sandwich the upper and lower sides of the print medium 3 that has been fed and be rotary driven so as to transport the print medium 3 in a transport direction L. The print head 2K is a full-line type inkjet print head having a width corresponding to that of the print medium 3 in a direction perpendicular to the transport direction L, and discharges only black ink to perform printing. The image data input unit 6 is a constituent element for inputting, from outside, data on an image that is desired to be printed with the inkjet printing device 1. The image data processing unit 7 converts the image data input to the image data input unit 6 into discharge data for each nozzle provided in the print head 2K. The upper limit setting unit 10 is a constituent element for inputting a setting value of a print duty, which will be described later, for controlling the amount of ink discharged on the print medium 3. The preliminary discharge image data storage unit 8 is a constituent element that stores a correspondence relationship between image data on an image (preliminary discharge image) printed by performing a preliminary discharge on the print medium and a print duty. The control unit 9 controls the discharge operation of the print head 2K and the drive of the transport rollers 5 based on data from the image data processing unit 7, the preliminary discharge image data storage unit 8 and the upper limit setting unit 10.

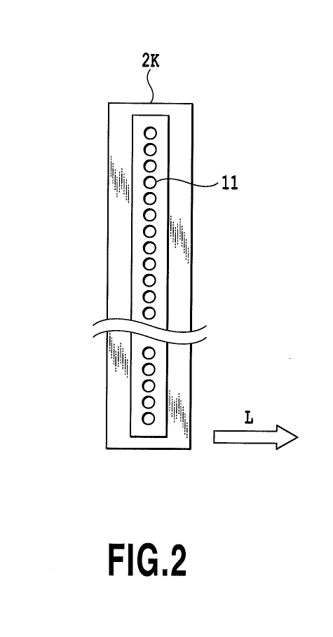

FIG. 2 is a schematic plan view showing an ink discharge surface of the print head 2K of the present embodiment. As shown in FIG. 2, in the print head 2K, a plurality of nozzles 11 for discharging ink are aligned at predetermined intervals on the same surface. Inside each of the nozzles, a heater (not shown) for applying energy for discharging ink is provided, and the individual heater is driven according to a discharge signal from the control unit 9 to discharge ink. After the discharge, ink is supplied (refilled) to the nozzles 11 from a common ink compartment (not shown) within the print head 2K, and, when a discharge signal is applied again to the heater, the nozzles 11 are possible to discharge the ink. In the present embodiment, in order to prevent a discharge failure of each of the nozzles 11 of the print head 2K, preliminary discharges for recovering the nozzles 11 are performed on the print medium at predetermined intervals.

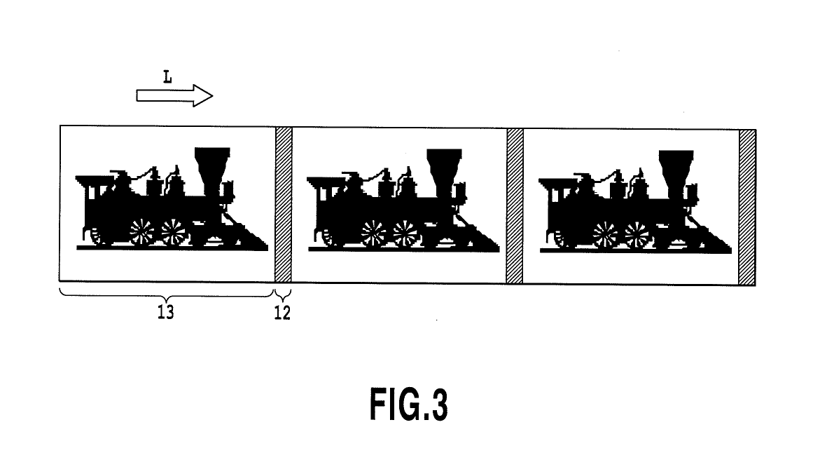

FIG. 3 is a schematic plan view showing a positional relationship between an image desired to be printed (hereinafter referred to as an objective image) and the preliminary discharge image printed by performing the preliminary discharge. In FIG. 3, the preliminary discharge image 12 is printed between a plurality of objective images 13 printed continuously. In FIG. 3, the preliminary discharge image 12 is a solid image formed by discharging ink a predetermined number of times evenly from all the nozzles corresponding to the width of the print medium in the direction perpendicular to the transport direction L of the print medium. The nozzles are periodically recovered by printing the preliminary discharge image 12 between the objective images 13.

In order to achieve the original purpose of the preliminary discharge to release ink having high viscosity resulting from evaporation, it is preferable to discharge ink from all the nozzles a predetermined number of times. In order to achieve an object of the present invention to reduce the consumption of the print medium, it is preferable to perform the preliminary discharge with a larger amount of ink per unit area of the preliminary discharge image 12. From the standpoint described above, the inventors of the present invention have examined a device and a method for reducing the consumption of a print medium.

Here, what is important is that, although in the printing of the objective image, an upper limit for the amount of ink discharged onto the print medium exists in terms of image quality, especially bleeding such as ink blurring in images, bleeding is permissible because the preliminary image finally becomes trash. Hence, when an upper limit for the amount A of ink per unit area that can be used for printing the objective image, that is, that satisfies the bleeding performance of the image is set to be “Alim”, the amount B of ink per unit area that exceeds the upper limit Alim can be used for printing the preliminary discharge image. On the other hand, when a significantly large amount of ink is discharged for the preliminary discharge image, a problem such as a stain occurs in which ink that is not absorbed and that overflows the print medium adheres to a transport unit such as the transport roller and is transferred to the print medium. In order to cope with this problem, it is necessary to additionally set an upper limit Blim (upper limit Blim>upper limit Alim) for the amount B of ink per unit area that prevents the adherence of ink to the transport unit and the stain of the print medium resulting from the transfer of the adhered ink.

As described above, in the present invention, the amount of ink per unit area that is larger than the upper limit Alim, that is, the upper limit amount A of ink causing no bleeding in the image of the print medium but is equal to or less than the upper limit Blim causing no stain of the transport unit and print medium resulting from ink overflow is used for the printing of the preliminary discharge image.

In the present invention, the amount of ink per unit area of the print medium for the objective image and the preliminary discharge image can be regulated by controlling the discharge of ink on the print medium by the inkjet printing device based on the “print duty”. In the present specification, the “print duty” is specified as a ratio (unit:%) of the amount of ink actually used for the printing with reference to the state in which an amount of ink of a predetermined volume is discharged in a unit area on the print medium. The “predetermined volume” is a preset constant volume; for example, it can be the volume of ink when printing is performed by executing one ink discharge for one pixel. In the present embodiment, as the “predetermined volume”, an ink amount of 8.6 μl/square inch (corresponding to eight ink discharges to a pixel of 600 dpi when the volume of an ink drop is 3 pl) is employed.

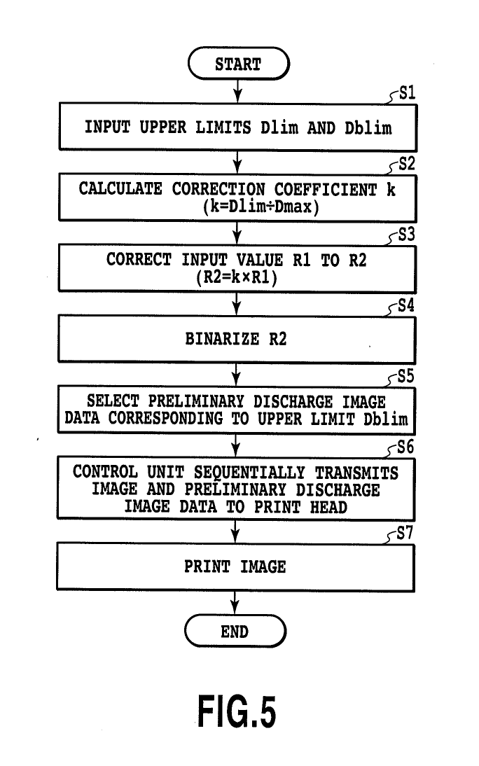

The inkjet printing device and the inkjet printing method of the present invention will be described in detail with reference to FIGS. 1 to 5.

The printing of the objective image will first be described among the printing of the objective image and the preliminary discharge image. The printing of the objective image is performed with the amount of ink per unit area that is equal to or less than the upper limit Alim for the amount of ink per unit area that causes no bleeding in the image of the print medium. A print duty for achieving the amount Alim of ink per unit area is set to be Dlim (%). The Dlim (%) is an upper limit for a print duty D (%) for performing printing without bleeding being caused on an image. The upper limit Alim or Dlim depends on ink used and quality such as the absorption of ink into the print medium, and is basically characteristic of the print medium. Hence, upper limits Dlim for various print media intended to be used for the inkjet printing device are determined by previously performing printing tests using various print duties D for the print media and visually checking whether or not bleeding occurs.

In order for the objective image 13 to be printed, at the upper limit setting unit 10 of the inkjet printing device, an upper limit Dlim (%) of the print duty on the print medium 3 used is first input (step S1). On the other hand, image data on the objective image 13 are input at the image data input unit 6, for example, as an input value R1 of 256-level gradation of 8 bits per pixel. In the above description, the upper limit Dlim of the print duty and the image data R1 are input in this order; the present invention is not limited to this order in which they are input.

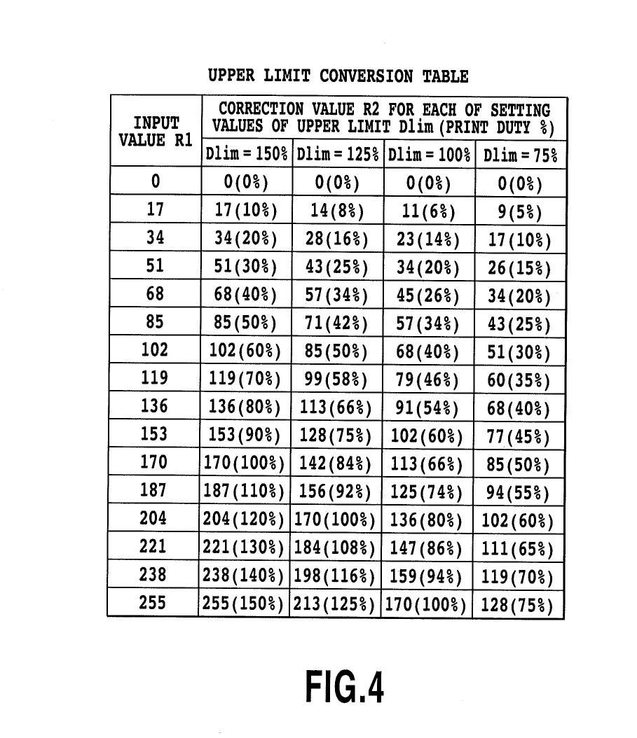

The image data processing unit 7 references an upper limit conversion table that is previously determined according to the upper limit Dlim which has been input, and corrects the input value R1 for the image data on each pixel to a correction value R2. This correction is performed so as to prevent bleeding from being caused in printing within the output setting range of the inkjet printing device. A description will be given showing an example of the upper limit conversion table in FIG. 4. The input value R1 is data of 256-level gradation ranging from 0 to 255. The corresponding correction value R2 is individually set for the upper limit Dlim for the print medium used. This example deals with a case where there are four upper limits Dlim (%) for various print media intended to be used for the inkjet printing device, that is, 150%, 125%, 100% and 75%. The maximum value (hereinafter referred to as Dmax (%)), namely, 150% among the upper limits Dlim for various print media intended to be used is set to be a reference for the correction, and a signal for the input data is corrected. The correction value R2 is obtained by multiplying the input value R1 by a correction factor k (that is, Dlim for the print medium used÷Dmax) calculated from the relationship between Dmax and Dlim for the print medium used (step S2). For example, when the upper limit Dlim of the print duty input at the upper limit setting unit 10 is 150%, the correction factor is 1 (=150÷150), and thus R2 is equal to the input value R1 (substantially, no correction). When the upper limit Dlim of the print duty input at the upper limit setting unit 10 is 100%, the input value R1 for each pixel is converted into a value R2 obtained by multiplying the input value R1 by a correction factor of 0.67 (=100÷150) (step S3).

Then, the image data processing unit 7 converts the value R2 into binary data corresponding to the discharge signal for each of the nozzles 11 in the head, and outputs the binary data to the control unit 9 (step S4). When the value R2 is converted into the binary data, the conversion is performed such that values R2 ranging from 0 to 255 correspond to print duties ranging from 0% to 150%. In FIG. 4, the values R2 linearly correspond to the print duties ranging from 0% to 150% (based on an equation “print duty=R2÷ 255×150”). The data processing described above is performed, and thus it is possible to print an image on a print medium such that the print duty for any input value R1 does not exceed the upper limit Dlim of the print duty for the print medium. Consequently, in the printing of the objective image within the output setting range of the inkjet printing device, no bleeding in the image is caused. The upper limit Dlim of the print duty for the print medium used, the maximum value Dmax for various print media intended to be used and the correction factor, which are described above, are included in a preferred example of the present invention; the present invention is not limited to this.

Then, the method of printing the preliminary discharge image will be described. The printing of the preliminary discharge image is performed by using the amount B of ink per unit area that is equal to or less than the upper limit Blim for the amount of ink per unit area that causes no stain in a transport means and a print medium resulting from the overflow of ink. The print duty for achieving the amount Blim of ink per unit area is set to be Dblim (%). Dblim (%) is an upper limit of the print duty for performing printing that causes no stain in a transport means and the like. The upper limit Blim or Dblim depends on ink to be used and quality such as the absorption of ink into the print medium, and is basically characteristic of the print medium. Hence, the upper limits Dblim for various print media intended to be used for the inkjet printing device are determined by previously performing printing tests by using various print duties for the respective print media and visually checking whether or not bleeding occurs.

The relationship between the print duty and the image data which are used in the printing of the preliminary discharge image will now be described. The printing of the preliminary discharge image on the print medium is performed so as to restore the nozzles. Hence, the image data on the preliminary discharge image is preferably data which specifies the quantity of discharges of ink printed in the pixel corresponding to each of the nozzles such that the nozzles each release the same number of discharges of ink. In this example, as described above, as the predetermined volume, which is a reference for the print duty, an ink amount of 8.6 μl/square inch (corresponding to eight ink discharges to a pixel of 600 dpi when the volume of an ink drop is 3 pl) is employed. If a nozzle pitch (resolution) is set as 120 dpi, when the preliminary discharge image of, for example, 100% print duty is printed, image data for releasing four ink drop discharges per each of the nozzles to the pixels of 600 dpi is used. When the preliminary discharge image of, for example, 175% print duty is printed, image data for releasing seven (=4×175÷100) ink discharges per each of the nozzles to each of the pixels is used.

As described above, the upper limit Dblim (%) of the print duty for various print media used in the inkjet printing device and the corresponding preliminary discharge image data are previously determined, and are stored in the preliminary discharge image data storage unit 8 of the inkjet printing device.

In the printing, the upper limit Dblim (%) of the print duty for the print medium to be used is input at the upper limit setting unit 10 of the inkjet printing device (step S1). In the printing operation, the control unit 9 selects the preliminary discharge image data corresponding to the upper limit Dblim (%) of the print duty that has been input from the print duties and the preliminary discharge image data previously stored in the preliminary discharge image data storage unit 8 (step S5).

As described above, based on the image data on the objective image that is output from the image data processing unit 7 to the control unit 9 and the image data on the preliminary discharge image selected by the control unit 9, the control unit 9 controls the discharge operation of the print head 2K and the driving of the transport rollers 5 (step S6). In this way, each of the objective image and the preliminary discharge image is printed by the discharge of ink in predetermined positions of the print medium in the same order in which the images are formed on the print medium (step S7).

In order to minimize the quantity of print media used in the printing of the preliminary discharge image, it is most preferable to use the upper limit Dblim (%) as the print duty used in the actual printing. In this example, the setting is performed as described above. However, it is easily understood that, when the print duty is set such that the print duty is more than the upper limit Dlim of the print duty causing no bleeding and is equal to or less than the upper limit Dblim of the print duty causing no stain in a transport unit and the like, it is possible to achieve an object of the present invention, that is, the reduction of the quantity of print media.

As described above, the preliminary discharge image is printed using a print duty D (≦Dblim) (%) higher than the possible upper limit Dlim (%) of the print duty for the objective image and thus, it is possible to reduce the quantity of print medium consumed as compared with the case where printing is performed using Dlim (%).

### Second Embodiment

Although the first embodiment shows the example in which the inkjet printing device includes the print head having one array of nozzles, the present invention can also be applied to an inkjet printing device having a plurality of arrays of nozzles. An example of an inkjet printing device including a print head having two arrays of nozzles will be described below. For ease of description, the constituent elements of the inkjet printing device, except the print head, of the second embodiment are the same as in the first embodiment (see FIG. 1).

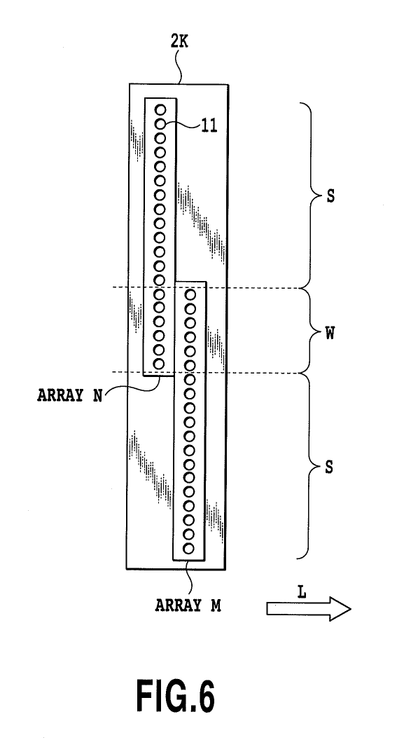

FIG. 6 is a schematic plan view showing the ink discharge surface of a print head 2K of the present embodiment. Two arrays of nozzles, that is, an array N and an array M, are so arranged as to be displaced in the width direction (direction perpendicular to the transport direction L of the print medium) of the print medium, parts thereof (indicated by “W” in the figure) overlap each other and the other parts (indicated by “S” in the figure) do not overlap each other. When the objective image is printed, the nozzles arranged in an overlapping portion W are configured to print an image while two nozzles arranged in the same array in the transport direction L of the print medium are sharing the discharge of ink.

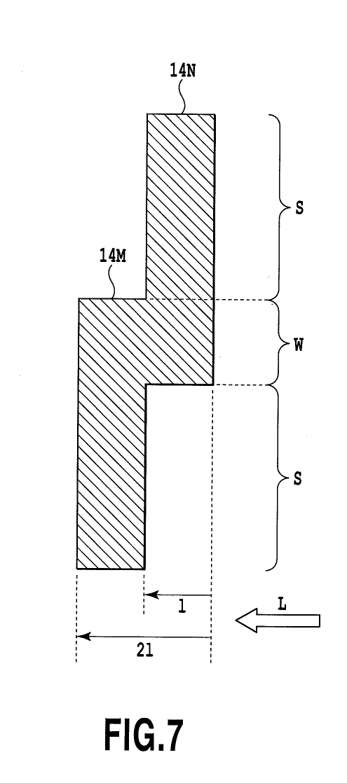

In FIG. 7, an example is shown of a preliminary discharge image printed by an inkjet printing device including the print head of FIG. 6, using a print duty of Dlim (%). In the case of the two arrays of nozzles, the same quantity of preliminary discharge for each of the nozzles is performed sequentially array by array, and thus it is possible to obtain a preliminary discharge image that is a solid image as shown in FIG. 7 (14N and 14M in the figure). In this type of printing pattern, for the portion W where the arrays of nozzles overlap each other in the transport direction L of the print medium, the print medium is consumed of a distance 21 twice as long as a distance l required for the preliminary discharge at the time of one array of nozzles. When, as described above, the same quantity of preliminary discharge for each of the nozzles is performed sequentially array by array, as the number of arrays of nozzles overlapping each other in the transport direction L of the print medium in one print head is increased, the length of the print medium necessary to perform the preliminary discharge increases with the number of arrays of nozzles.

However, even in the case of any number of arrays of nozzles, the same effects of the present invention as in the case of one array of nozzles are acquired. In other words, in the printing of the preliminary discharge image, when a print duty D (≦Dblim) (%) higher than the upper limit Dlim (%) of the print duty for the objective image is employed, it is possible to reduce the quantity of print medium consumed as compared with the case where Dlim (%) is employed.

### Third Embodiment

Although the first and second embodiments deal with an example where the inkjet printing device includes one print head, the present embodiment deals with an example where a plurality of print heads are used.

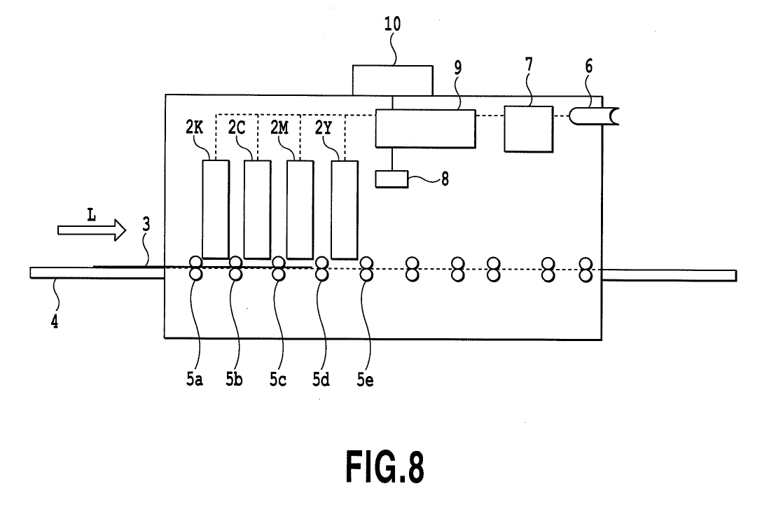

FIG. 8 is a schematic side view showing the configuration of an inkjet printing device including four print heads of the present embodiment. In FIG. 8, the print heads 2K, 2C, 2M and 2Y are filled with inks of different colors; the colors of inks for the print heads are black K, cyan C, magenta M and yellow Y, respectively. In front of and behind each of the print heads, the transport rollers 5 (pairs of rollers 5a to 5e) for transporting the print medium are arranged. While the transport rollers 5 transport the print medium in the direction L indicated by an arrow in the figure, the control unit 9 individually controls the print heads, and the print heads discharge the inks in predetermined positions of the print medium to form a color image. The other symbols in FIG. 8 show the same constituent elements as in FIG. 1.

When a plurality of print heads are included, it is possible to achieve the following improvements in the method of printing the preliminary discharge image, and thus the printing of the preliminary discharge image can be performed using a higher print duty. Consequently, it is possible to further reduce the length of the print medium consumed for the printing of the preliminary discharge image, that is, the preliminary discharge. A detailed description will be given below.

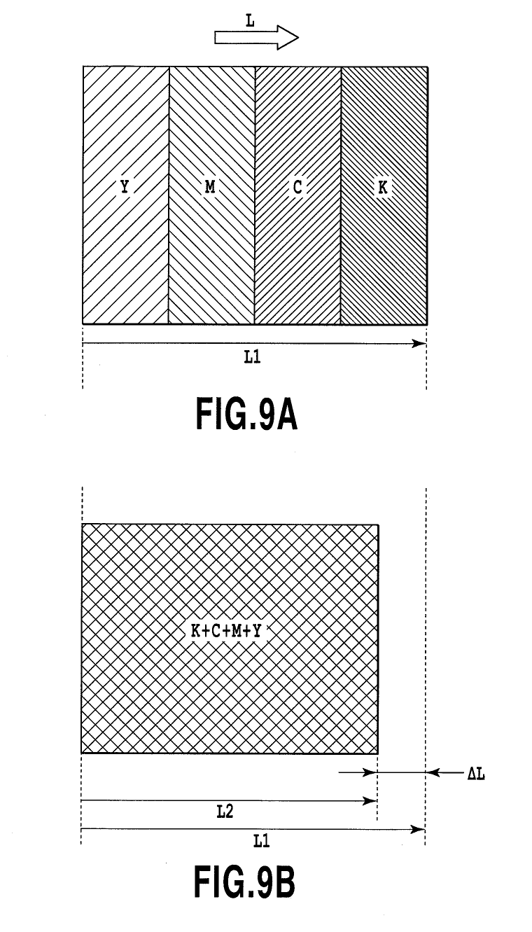

FIGS. 9A and 9B show a schematic plan view of preliminary discharge images printed by the inkjet printing device including the four print heads shown in FIG. 8. FIG. 9A shows the preliminary discharge image (before the improvements) obtained by performing the preliminary discharge of the ink of each of the four colors in the corresponding area on the print medium. On the other hand, FIG. 9B shows the preliminary discharge image (after the improvements) obtained by performing the preliminary discharge of the inks of the four colors in the common area on the print medium.

With respect to the print medium used in an example shown in FIGS. 9A and 9B, the upper limits Dblim (%) of the print duties for the preliminary discharge images that are previously determined for each of the inks of colors K, C, M and Y are, for example, set to be the same value, 160%. In the pattern before the improvements shown in FIG. 9A, the preliminary discharge image is printed in the area of each of the colors having a length of one fourth of L in the transport direction L of the print medium, using the 160% print duty. Even in this case, since Dblim is larger than the upper limit Dlim of the print duty for the objective image, the effect of reducing the consumption of the print medium according to the present invention is already achieved as in the first and second embodiments.

By contrast, in FIG. 9B, for the ink of each of the colors, the printing is performed in the common area having a length of L2 in the transport direction L of the print medium. Consequently, the pixels of the four colors are mixed throughout the area of the preliminary discharge image. Since the preliminary discharge is the operation for coping with the discharge failure resulting from the evaporation of the ink solvent, a minimum number of discharges of ink necessary to do so should be performed. In other words, preferably, when the discharge is performed in the entire area common to the inks of the colors, as compared with the case where the discharge is performed in each area divided by the colors, the minimum number of discharges is equally performed in the large area. Thus, the print duties actually used for the inks of the colors or the print heads are less than Dblim (%) that is previously determined.

For example, the discharge of the ink to be performed in the area having a length of one fourth of L1 in FIG. 9A is carried out in the area having a length of L2 in FIG. 9B. Here, if L1=L2, in the pattern obtained by performing the discharge in the entire area common to the inks of the four colors in FIG. 9B, as the print duty D for the ink of each of the colors, a value of 40% can be used in common (because 160×L1/4=D×L2). Thus, the printing is performed over the entire preliminary discharge image using a total of the print duties of the four colors, that is, 40%×4=160%. In the following description, the print duty for the ink of each of the colors or for each of the print heads is set to be De (%), and a sum of the print duties for the inks of all the colors or for all the print heads is set to be a sum print duty Ds (%).

The inventors of the present invention have found that, in the pattern of FIG. 9B, the printing can be performed without overflow of ink using the sum print duty Ds (%) more than the Dblim of 160% that is determined previously. In other words, as shown in FIG. 8, the print heads for the inks of the four colors are spaced in order at a predetermined distance apart in the transport direction L of the print medium. Hence, a time difference is present in the discharge and the absorption of the inks in the print medium between the colors of the inks discharged in the common area on the print medium. For example, most of the black ink discharged from the upstream print head 2K is absorbed in the print medium until it reaches the most downstream print head 2Y. Likewise, a moderate amount of inks of cyan and magenta discharged from the print heads 2C and 2M is absorbed in the print medium until it reaches the most downstream print head 2Y. Hence, even if the inks are discharged from a plurality of print heads in the common area on the print medium and thus the sum of each print duty De is more than the Dblim of 160% that is determined previously, a sum print duty Ds that prevents the inks from being adhered to any pair of rollers in the transport roller is present.

The upper limit of the sum print duty Ds (%) can be determined by performing printing tests in the printing pattern of FIG. 9B having the common printing area while variously changing the print duty De (%) used for the print heads and visually checking whether or not a stain is present in a transport unit or the like. For example, in the printing pattern of FIG. 9B, values of 45% and 50% are assumed to be employed as the print duty De for the ink of each color or for each print head. In this case, the sum print duty Ds obtained by totaling the four colors is 180% (=45%×4) and 200% (=50%×4), and both values exceed the print duty Dblim of 160% in the case of FIG. 9A. If no stain in the transport means is present when Ds is 180% and a stain in the transport means is found when Ds is 200%, a value of 180% is assumed to be an upper limit Dslim of Ds for the print medium. Here, in the printing pattern of FIG. 9B, L2 is a length of about 89% of L1 (from the formula 45×L2=160×L1/4), and thus it is possible to further reduce the consumption of the print medium by about 11% as compared with the printing pattern of FIG. 9A (see ΔL in the figure). Although, in this example, 45% and 50% are employed as various kinds of De, and Dslim (%) is determined, this is simply an example, and the sum Dslim (%) may be determined using other various kinds of De.

As described above, by the printing method of the present invention in which the discharges from a plurality of print heads are performed in the common area, it is possible not only to prevent a stain in the transport means or the like but also reduce the length of the print medium consumed by the preliminary discharge image as compared with the case where the discharge is performed in the specific areas that differ for each of the print heads.

In the present embodiment, the example of the inkjet printing device including a plurality of print heads is shown. In the inkjet printing device including a plurality of arrays of inks in one print head as in the second embodiment, the printing pattern of the preliminary discharge image where the discharges from the overlapping arrays of inks are performed in the common large area is employed, and thus it is possible to reduce the length of the print medium consumed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-141659, filed Jun. 22, 2010, which is hereby incorporated by reference herein in its entirety.

What is claimed is:

1. An inkjet printing device that performs printing on a print medium with a print head including a nozzle for discharging ink, the inkjet printing device comprising:
a transport unit transporting the print medium;
a printing unit discharging the ink from the print head while said transport unit transports the print medium, such that the printing unit prints an image for printing on the print medium and an image formed by a preliminary discharge;
a first limiting unit limiting, based on image data on said image for printing, an amount of ink to be discharged per unit area of the print medium such that the amount of ink per unit area is equal to or less than an upper limit Alim; and
a second limiting unit limiting an amount of ink to be discharged per unit area of the print medium for said image formed by the preliminary discharge such that the amount of ink per unit area is more than said upper limit Alim and is equal to or less than an upper limit Blim.

2. The inkjet printing device of claim 1,
wherein said upper limit Alim is an upper limit amount of ink per unit area of the print medium which causes no bleeding in an image on the print medium.

3. The inkjet printing device of claim 1,
wherein said upper limit Blim is an upper limit amount of ink per unit area of the print medium that causes no stain in a transport unit and on the print medium resulting from overflow of ink discharged on the print medium.

4. The inkjet printing device of claim 1,
wherein, based on a print duty specified as a ratio of an amount of ink per unit area of the print medium actually used for the printing with reference to a state where an amount of ink having a predetermined volume is discharged on a unit area of the print medium, the amount of ink to be discharged per unit area of the print medium based on image data on said image for printing and the amount of ink to be discharged per unit area of the print medium for said image formed by the preliminary discharge are limited.

5. The inkjet printing device of claim 1,
wherein said print head is a full-line type inkjet print head including a plurality of nozzle arrays comprising a plurality of nozzles, and
an amount of ink discharged for an image formed by the preliminary discharge through each of the nozzles arranged in a portion where a plurality of nozzles overlap each other in a direction in which the print medium is transported is set such that the amount of ink to be discharged per unit area of the print medium for said image formed by the preliminary discharge, that is, a total of discharges through each of the nozzles, is equal to or less than said upper limit Blim.

6. The inkjet printing device of claim 1,
wherein said inkjet printing device comprises a plurality of said print heads, and
when each of the plurality of said print heads prints an image formed by the preliminary discharge in a common area on the print medium, said upper limit Blim higher than when the image formed by the preliminary discharge is printed in a different area on the print medium, is set.

7. A method of using an inkjet printing device that performs printing on a print medium with a print head including a nozzle for discharging ink to thereby print an image for printing and an image formed by a preliminary discharge on the print medium, the method comprising the steps of:
printing, based on image data on said image for printing, said image for printing by using an amount of ink per unit area of the print medium that is equal to or less than an upper limit Alim; and
printing said image formed by the preliminary discharge by using an amount of ink per unit area of the print medium that is more than said upper limit Alim and is equal to or less than an upper limit Blim.
